(19) United States
(12) Patent Application Publication
(10) Pub. No.: US 2021/0143755 A1
(43) Pub. Date: May 13, 2021

(54) Electrostatic repulsion motor

(71) Applicant: Nathanial Henry Lewis, Fallon, NV (US)

(72) Inventor: Nathanial Henry Lewis, Fallon, NV (US)

(21) Appl. No.: 16/602,624

(22) Filed: Nov. 12, 2019

(51) Int. Cl. H02N 1/00

(52) U.S. Cl. CPC H02N 1/002

(57) ABSTRACT

Mechanical energy is generated at the axle of the rotor of this electrostatic motor by the electrostatic energy going into the motor. The electrostatic motor comprises a rotor adjacent a stator and there are changing lines and a discharging line. A continuous repeating of the charging and discharging sequences produces continuous rotation of the rotor. An important property of the electrostatic motor is that they can operate from a much greater variety of electrical sources; the electric field of the earth is one example.

### BACKGROUND OF THE INVENTION

An electrostatic motor develops mechanical force through electrostatics forces between electric charges that are generated by relatively low direct current (DC) at high voltage. Electrostatic motors are based on the force of mutual attraction between unlike charges and the mutual repulsion of like charges. In nature the electrostatic forces are much stronger than the electromagnetic ones. Interesting sources of electricity for electrostatic motors are the ordinary capacitor and the electric field of the earth.

### BRIEF SUMMARY OF THE INVENTION

The basic nature of the science of electrostatic is the study of electric charges at rest relative to one another; not in motion, as in electric currents. Electrostatic motors are extremely simple in design and require no expensive materials. Having only a few metal parts they possess a very good power-to-weight ratio. They can attain very high speeds; they have been built with speeds from 1000 rpm to 6000 rpm. Electrostatic motors bearings have to be of a very low friction. Electrostatic energy in a concentrated amount is the second most powerful type of energy, nuclear energy being first. An example would be lighting caused by electrostatic energy built up between the many large positive and negative charges inside clouds.

### BRIEF DESCRIPTION OF THE DRAWING

FIG. 1 is a side view of the rotor with its axle.

FIG. 2 is a partial front view of the rotor and its axle.

FIG. 3 is a side view of the stator.

FIG. 4 is an upper section view of FIG. 3.

FIG. 5 is a lower section view of FIG. 3.

FIG. 6 is a side view of an assembly of an electrostatic repulsion motor.

FIG. 7 is a front view of FIG. 6.

FIG. 8 is a partial side view of the motor and the entire stator is shown section, see FIG. 6 also.

FIG. 9 is a partial section view of a charging assembly or a discharging assembly for the rotor.

FIG. 10 is a side view of a typical side hole with a plurality of fine wires.

FIG. 11 is a top view of an electrical insulating cover cap connected to a typical electric line.

FIG. 12 is a side view of the electrical insulating cover cap connected to a typical electric line.

FIG. 13 is a bottom view of the electrical insulating cover cap showing its plurality of fine wires.

### DETAIL DESCRIPTIONS

Refer to FIGS. 1 and 2 for the construction of the rotor 20 with its axle 20A. The rotor 20 is made from a material that is strong, tough and has good electrical insulation properties. The rotor axle 20A should be made from metal. The rotor 20 is a disk with parallel sides and a rim 20C with a thickness T around the rotor 20.

Equally spaced and equal size side holes 20B with a circle that can pass through their centers, and are on one side of the rotor 20. Each side hole 20B is drilled so that it intersects perpendicular to drilled rim hole 20D through the center of the rim 20C of the rotor 20. See FIG. 9.

The distance of the circle D through the centers of the side holes 20B to the rotor rim 20C will vary with the rotor 20 size. The distance should be within a 0-3 inches range.

Each side hole 20B of the rotor 20 is perpendicular to its adjoining rim hole 20D. Each side hole 20B should have an opening area (A) approximately two (2) times the opening area (A) of the rim hole 20D. The following is an example, a ⅜ inch diameter hole to a¼ inch diameter hole.

Refer to FIGS. 3, 4 and 5 for the construction of the stator 30. The stator 30 is made from a material that is strong, tough and has good electrical insulation properties and made in a curved shape. It has parallel sides and an inner curved surface 30B. The curved stator 30 will vary in width W, thickness T and its curved length depending on the size of the rotor 20. The curvature of the stator inner surface 30B has to fit the curvature of the rotor rim 20C.

A V-shape groove 30C with enough depth for the pointed metallic prongs 70 to pass through the stator 30 freely. The V-shape groove 30C is cut along the center line of the inner surface 30B of the stator 30 and throughout the stator 30 length.

An inclined surface 30D at the top of the stator 30 has a width that is approximately 75 percent of the stator width W and has the stator thickness T. The inclined surface 30D is sloping rearward and downward at an angle Y between 25 and 35 degrees, the angle Y is between an above extension line (horizontal plane) 150 from the top of the stator 30 down to the inclined surface 30D of the stator 30.

An angled hole 30A for mounting a pointed metallic prong 40C into the stator 30 is drilled perpendicular near the top, or near the bottom, or in the center of the inclined surface 30D and down into the center of the V-shape groove 30C, which is in the center of the inner surface 30B of the stator 30. And when the V-shape groove 30C and angled hole 30A meets in the stator 30, they form a chamber for the electrostatic forces. The angled hole 30A and the side hole 20B on the rotor 20 should be approximately equal diameters.

The V-shape groove 30C, the inclined surface 30D and the angled hole 30A of the curved stator 30, have different dimensions depending on the size of the stator 30. The placement of the V-shape groove 30C dimensions C is shown.

Refer to FIGS. 6 and 7 for the construction of the electrostatic repulsion motor 100. The rotor 20 and stator 30 are mounted adjacent each other, close but not touching. A charging assembly comprises a main charging line 40 in parallel with a rotor charging line 40A and a stator charging line 40B. And there is a rotor discharging line 50 of a discharging assembly.

Pointed metallic prongs 70 are mounted around the rotor rim 20C. The power needed by a motor 100 would determine the size of its rotor 20 and stator 30. There would be different hole sizes and distances within each particular size of rotor 20 and its stator 30.

The axle 20A bearings of all electrostatic motors have to be of very low friction. An option would be to add a permanent connector PC between the two shown electrical insulation cover caps 50B; see FIGS. 6 and 11.

Refer to FIGS. 8 and 9 for the construction of the rotor 20 and stator 30 charging assembly and the rotor 20 discharging assembly. The rotor charging line 40A and the rotor discharging line 50, each has sharp metal wires 50A exposed at their ends. A plurality of sharp metal wires 50A are sheltered in an electrical insulation cover cap 50D. The stator charging line 40B has a pointed metallic prong 40C mounted in a stabilizing, round electrical insulation plug 40D, both inturn are mounted into the angled hole 30A of the stator 30.

Refer to FIG. 9 for the construction of the electric circuit within each rotor side hole 20B and its adjoining, perpendicular rotor rim hole 20D for holding a pointed metallic prong 70. The prong 70 is in electrical contact with a metallic cylindrical base 60 in the adjoining side hole 20B, and there are sharp metal wires 60A soldered to the metallic cylindrical base 60 for each rotor side hole 20B; this is the electric circuit within each rotor side hole 20B. Each pointed metallic prong 70 should be of such diameter and length in its respectful rotor rim hole 20D, as to have the physical strength and electrical conductivity to produce the rated power of its motor 100.

Coulomb's law says that two point charges with the same type of charge will repel each other, and if they have opposite charges they will attract each other. A greater concentration of electric lines of force builds up on a pointed metallic surface more than on a non-pointed metallic surface; the concentration of the lines of force vary directly with the degree of curvature of a metallic surface.

Refer to FIGS. 8 and 9 for the operation of the electrostatic repulsion motor 100. For CHARGING POSITION 80, the stator pointed metallic prong 40C and a rotor pointed metallic prong 79 are opposite each other in the chamber (cavity), when charged simultaneous they will repel each other. The rotor 20 will rotate 200 placing the rotor prong 70 in the DISCHARGING POSITION 90 below the chamber. Both prongs 40C and 70 has equal diameters.

For both POSITIONS 80 and 90, the proper alignment of the rotor 20 and its stator 30, two adjacent electrical insulation cover caps 50B are mounted over the rotor circle of side holes 20B and mounted close to two of the side holes 20B, and over but not touching them. And the holes 20B are adjacent the stator 30 and its pointed metallic prong 40C within.

There is an exchange by electrostatic induction of electric charges between each electrical insulation cover cap 50B and the side hole 20B it is over, which leads to a pointed metallic prong 70 on the rotor rim 20C. Each pointed metallic prong 70 around the rotor rim 20C is charged and discharged producing continuous rotation 200 of the motor rotor 20. The pointed metallic prong 40C in the stator 30 remains in a charged state.

Refer to FIGS. 10, 11, 12 and 13 for detail views of the parts used in charging and discharging the rotor pointed metallic prongs 70. Electric charges from the sharp metal wires 50A sheltered in the electrical insulation cover cap 50B and connected to the electric line 40A, and passes to the sharp metal wires 60A sheltered in a side hole 20B of the rotor 20. The discharging line 50 is shown.

The electrostatic repulsion motor 100 is more practical than other types of electrostatic motors, such as the induction motors, contact motors, dielectric motors, spark motors, electret motors and corona motors. This motor 100 would have many applications.

Electrostatic motors are design to be powered by electric forces created by stationary charges, excess electrons or protons. Our present day electric motors (electromagnetic ones) are design to be powered by magnetic forces created by moving charges (current), excess electrons. The electrostatic motor will be only a supplement to the electromagnetic motor, not a replacement.

I claim:

1. An electrostatic repulsion motor having a rotor adjacent a stator, a charging assembly and a discharging assembly, wherein:
said rotor is made from a material that is strong, tough and has good electrical insulation properties, the rotor axle should be made from a metal;
said rotor is made as a disk with parallel sides and a rim with an equal thickness around said rotor;
said rotor has equal spaced and equal size side holes on one side and with a depth to the center of said rotor;
said side holes, each is drilled so that it intersects perpendicular to a drilled rim hole in said center and through to the center of said rim of said rotor;
a distance between said circle that runs through said centers of said side holes and to said rotor rim, said distance should be within a 0-3 inches range;
each said side hole of said rotor is perpendicular to its adjoining said rim hole, each said side hole should have an opening area;
each said side hole has an electric circuit within, a plurality of sharp metal wires soldered to a metallic cylindrical base;
each said pointed metallic prong should be of such diameter and length in its respectful said rotor rim hole;
said stator is made from a material that is strong, tough and has good electrical insulation properties;
said stator is made in a curved shape with parallel sides and an inner curved surface with a curvature to fit the curvature of said rotor rim;
said stator V-shape groove is cut along the center of said inner curved surface and throughout said curved length of said stator;
said stator has an inclined surface at its top with a width that is approximately 75 percent of the width of said stator and has its thickness;
said stator has an angled hole for mounting one pointed metallic prong into said stator, said angled hole is drilled perpendicular to and near the top of said inclined surface and down into said center of said V-shape groove;
a chamber is formed when said angled hole meets said V-shape groove, said angled hole diameter should be equal to the side hole diameter of said rotor;
a charging line for said stator has said pointed metallic prong mounted at the end of said charging line, said prong is mounted in a stabilizing, round electrical insulation plug;
said motor has said rotor mounted adjacent to said stator, but not touching, there is said charging assembly compromising a main charging line in parallel with a rotor charging line and said stator charging line to said angled hole of said stator;
said rotor charging and discharging lines, each said line has a plurality of sharp metal wires projecting from said end, around said end and its said projecting sharp metal wires;
said cover cap of said charging line is mounted over a said side hole having said plurality of sharp metal wires projecting upward, said side hole is perpendicular to adjoining said pointed metallic prong within said rotor rim hole;
said cover cap of said discharging line is mounted over the next said side hole of said rotor and adjacent said charging cover cap.

2. An electrostatic repulsion motor having a rotor adjacent a stator, a charging assembly and a discharging assembly, wherein;
said rotor is made from a material that is strong, tough and has good electrical insulation properties, the rotor axle should be made from a metal;
said rotor is made as a disk with parallel sides and rim with an equal thickness around said rotor;
said rotor ahs equal spaced and equal size side holes on one side and with a depth to the center of said rotor;
said side holes, each is drilled so that it intersects perpendicular to a drilled rim hole in said center and through to the center of said rim of said rotor;
a distance between said circle that runs through said centers of said side holes and to said rotor rim, said distance should be within a 0-3 inches range;
each said side hole of said rotor is perpendicular to its adjoining said rim hole, each said side hole should have an opening area (A);
each said side hole has an electric circuit within, a plurality of sharp metallic wires soldered to a metal cylindrical base;
each said pointed metallic prong should be of such diameter and length in its respectful said rotor rim hole;
said stator is made form a material that is strong, tough and has good electrical insulation properties;
said stator is made in a curved shape with parallel sides and an inner curved surface with a curvature to fit curvature of said rotor rim;
said stator V-shape groove is cut along the center of said inner curved surface and throughout said curved length of said stator;
said stator has an inclined surface at its top with a width that is approximately 75 percent of the width of said stator and has its thickness;
said stator has an angled hole for mounting one pointed metallic prong into said stator, said angled hole is drilled perpendicular to and in the center of said inclined surface and down into said center of said V-shape groove;
a chamber is formed when said angled hole meets said V-shape groove, said angled hole diameter should be equal to said side hole diameter of said rotor;
a charging line of said stator has said pointed metallic prong mounted at the end of said charging line, said prong is mounted in a stabilizing, round electrical insulation plug;
said motor has said rotor mounted adjacent to said stator, but not touching, there is said charging assembly comprising a main charging line in parallel with a rotor charging line and said stator charging line to said angle hole of said stator;
said rotor charging and discharging lines, each said line has a plurality of sharp metal wires projecting from its end, around said end and its said projecting sharp metal wires;
said cover cap of said charging line is mounted over a said side hole having said plurality of sharp metal wires projecting upward, said side hole is perpendicular to adjoining said pointed metallic prong within said rotor rim hole;
said cover cap of said discharging line is mounted over the next said side hole of said rotor and blow adjacent said charging cover cap, and a permanent connector can be placed between said charging cover cap and its adjacent said discharging cover cap.

3. An electrostatic repulsion motor having a rotor adjacent a stator, a charging assembly and a discharging assembly, wherein;
said rotor is made from a material that is strong, tough and has good electrical insulation properties, the rotor axles should be made from a metal;
said rotor is made as a disk with parallel sides and a rim with an equal thickness around said rotor;
said rotor has equal spaced and equal size side holes on one side and with a depth to the center of said rotor;
said side holes, each is drilled so that it intersects perpendicular to a drilled rim hole in said center and through to the center of said rim of said rotor;
a distance between said circle that runs through said centers of said side holes and to said rotor rim, said distance should be within a 0-3 inches range;
each said side hole of said rotor is perpendicular to its adjoining said rim hole, each said side hole should have an opening area (A);
each said side hole has an electric circuit within, a plurality of sharp metal wires soldered to a metallic cylindrical base;
each said pointed metallic prong should be of such diameter and length in its respectful said rotor rim hole;
said stator is made from a material that is strong, tough and has good electrical insulation properties;
said stator is made in a curved shape unit with parallel sides and an inner curved surface with a curvature to fit the curvature of said rotor rim;
said stator V-shape groove is cut along the center of said inner curved surface and throughout said curved length of said stator;
said stator has an inclined surface at its top with a width that is approximately 75 percent of the width of said stator and has its thickness;
said stator has an angled hole for mounting one pointed metallic prong into said stator, said angled hole is drilled perpendicular to and near the bottom of said inclined surface and down into said center of said V-shape groove;
a chamber is formed when said angle hole meets said V-shape groove, said angled hole diameter should be equal to said side hole diameter of said rotor;
a charging line of said stator has said pointed metallic prong mounted at the end of said charging line, said prong is mounted in a stabilizing, round electrical insulation plug;
said motor has said rotor mounted adjacent to said stator, but not touching, there is said charging assembly comprising a main charging line in parallel with a rotor charging line and said stator charging line;
said rotor charging and discharging lines, each said line has a plurality of sharp metal wires projecting from its end, around said end and its said projecting sharp metal wires,
said cover cap of said charging line is mounted over a said side hole having said plurality of sharp metal wires projecting upward, said side hole is perpendicular to adjoining said pointed metallic prong within said rotor rim hole, and
said cover cap of said discharging line is mounted over the next said side hole of said rotor and adjacent said charging cover cap.
